(19) United States
(12) Patent Application Publication
(10) Pub. No.: US 2023/0032627 A1
(43) Pub. Date: Feb. 2, 2023

(54) WIRE FEEDING APPARATUS

(71) Applicant: SCHLEUNIGER AG, Thun (CH)

(72) Inventor: Peter SCHÜTZ, Solingen (DE)

(21) Appl. No.: 17/789,633

(22) PCT Filed: Jan. 13, 2020
(86) PCT No.: PCT/IB2020/050234

§ 371 Date: Jun. 28, 2022

(51) Int. Cl. H01R 43/052; B65H 51/14; B65H 51/18; B65H 51/32

(52) U.S. Cl. CPC H01R 43/052; B65H 51/14; B65H 51/18; B65H 51/32; B65H 2701/36

(57) ABSTRACT

The invention relates to a wire feeding apparatus (3) for feeding a wire (1, 2) to a wire processing station (9), comprising, along a wire transport path (7): —a first wire pre-treatment device (10), which preferably has at least one straightening unit for straightening a wire (1), —a wire conveyor (4) for conveying the wire (1, 2) along the wire transport path (7) in a working transport direction (8), comprising a wire input (5), and—a first wire transfer device (11), which is associated with the first wire pre-treatment device (10), for transferring the wire (1) to the wire conveyor (4) in the region of the wire input (5), characterised in that the first wire transfer device (11) is positioned, in its working position, in the region of the wire input (5) of the wire conveyor (4) and can be moved out of its working position, preferably by means of at least one drive (12, 31).

This application is a National Stage completion of PCT/IB2020/050234 filed Jan. 13, 2020.

### FIELD OF THE INVENTION

The invention relates to a wire feeding apparatus for feeding a wire to a wire processing station according to the independent claim(s); also a wire processing apparatus and a method for handling at least one wire by means of a wire feeding apparatus.

### BACKGROUND OF THE INVENTION

EP3219654B1 discloses a cable processing device with an finishing station, a cable conveyor device for conveying the cable to the finishing station, and a cable pre-processing station with a straightening unit for straightening a cable. A detection device connected to the control device detects the working position of the straightening unit. When the working position is reached, the cable conveyor device is activated for threading the cable, and/or when the cable leaves the working position the cable conveyor device is activated for unthreading the cable. While the cable conveyor device is activated for threading the cable, the operator can then push the new cable into the infeed defined by a guide tube without pressing a button until the cable is gripped by the belt drive of the cable conveyor device. In one embodiment, the cable pre-processing station comprises two straightening units which are displaceable transversely to the longitudinal axis of the machine, wherein the straightening units form a cable replacement system for selectively feeding cables to the finishing station.

A disadvantage of this solution is that the cable must be threaded into the cable conveyor device or the infeed thereof manually by the operator. This is not only a complicated procedure which is vulnerable to error, it is also very time-consuming, with the result that long pauses in the production workflow must be taken into account.

### SUMMARY OF THE INVENTION

Accordingly, the objective of the present invention consists in overcoming the disadvantages arising from the related art and providing a wire feeding apparatus with which the replacement and/or removal of a wire is simplified. In turn, this should reduce the necessary time commitment and minimise the interruptions in production associated with replacing cables. It is further intended to create the capability for largely automating the cable replacement procedure.

This goal is achieved with a wire feeding apparatus as described in the introduction in such manner that the wire feeding apparatus comprises along a wire transport path:
a first wire pre-processing device, which preferably has at least one straightening unit for straightening a wire,
a wire conveyor for conveying the wire along the wire transport path in a working transport direction, with a wire input, and
a first wire transfer device assigned to the first wire pre-processing device for transferring the wire to the wire conveyor in the area of the wire inlet,

wherein the first wire transfer device is positioned in its working position in the area of the wire inlet of the wire conveyor and is movable, preferably by at least one drive, from its working position, preferably into an idle position outside the wire transport path.

At this point it should be noted that the term “wire” may include an electrical wire or also an optical cable. The wire may be insulated or bare. The wire may have one or more conductors—combined to form a conductor bundle. The one or more conductors may also be surrounded by shielding and/or insulation, for example. In particular, the wires may be flexible and/or bendable.

The wire is preferably a cable, for example a power cable, a data cable, a fibre optic cable, or the like. For the preferred case in which the wire(s) is/are one or more cables, the wire-related devices are a cable feeding device, a cable transfer device, a cable conveyor, a cable processing apparatus/cable processing station, etc.

In its working position, the wire transfer device for transferring the wire to the wire conveyor is located close to the wire input of the wire conveyor. If the wire transfer device is designed to be movable out of its working position, it then also becomes possible for a wire to be brought out of or into the operating range of the wire conveyor by means of the wire transfer device. This means that this movement of the wire no longer has to be performed manually, which turn not only helps to make the process simpler and shorter, but also creates the conditions that would enable automation.

The wire transfer device serves both to transfer the wire to the wire conveyor and to pick up the wire or the end of the wire from the wire conveyor.

The wire transfer device can be moved relative to the wire input of the wire conveyor. In other words: The wire transfer device is movable from the working position (in the area of the wire input of the wire conveyor) into another position which is at a (greater) distance from the wire input.

In its working position, the wire transfer device is located in the wire transport path between the wire pre-processing device and the wire conveyor.

The wire is transported along its longitudinal extension by the wire feeding apparatus.

The wire transport path is understood to be the path or line along which the wire is moved—along its longitudinal extension—by the wire feeding apparatus. When the wire feeding apparatus is working, the wire passes through—along the wire transport path—in the following order: the wire pre-processing device, the wire transfer device and the wire conveyor, to then be directed towards the processing station.

The wire pre-processing device preferably comprises at least one straightening unit for straightening the wire. The straightening unit comprises an roller assembly which bear on the wire from opposite sides as it is transported and “straighten it out” in similar manner to a rolling process. The straightening unit may include an actuator, the operation of which causes the roller assembly to be shifted to a position that allows the wire to pass freely. This makes replacing the wire easier. The straightening unit may include pins or lugs between the straightening rollers, as well as in front of, behind or between the straightening units, so that the entire straightening unit area forms a kind of “channel”, which prevents the wire from deviating from the travel direction axis or buckling even when it is transported backwards with the straightening units open.

The straightening unit preferably includes two sections, wherein the axes of rotation of the rollers of the one section are inclined with respect to the axes of rotation of the rollers of the other section, preferably at an angle of substantially 90°.

In the case of two pre-processing devices—as described hereafter—the straightening units thereof may be of similar or identical construction.

A preferred embodiment is characterized in that the wire feeding apparatus comprises a second wire pre-processing device, which preferably includes at least one straightening unit for straightening a wire, and a second wire transfer device assigned to the second wire pre-processing device for transferring the wire to the wire conveyor in the area of the wire input, and that the second wire transfer device in its working position is positioned in the area of the wire input of the wire conveyor, and is movable preferably by at least one drive from its working position, preferably into an idle position outside of the wire transport path. The first wire transfer device and the second wire transfer device may be selectively brought into their respective working positions. This means that while the one wire transfer device is in its working position, the other wire transfer device is located outside of its working position. In this way, the desired wire can always be conveyed to the wire processing station by the wire conveyor while the other wire remains in a standby or idle position. The wire transfer device that is currently in the standby or idle position also allows a wire to be replaced, which the wire transfer device which is in the working position allows the transport of another wire, thereby enabling an uninterrupted production workflow.

A preferred embodiment is characterized in that in its working position the first wire pre-processing device is positioned in the wire transport path, and is movable, preferably by a drive, from the working position into an idle position outside of the wire transport path.

A preferred embodiment is characterized in that in its idle position the second wire pre-processing device is arranged outside the wire transport path and is movable, preferably by a drive, from the idle position outside the wire transport path into a working position in which the wire pre-processing device is positioned in the wire transport path.

This makes it possible to introduce or thread a wire into a wire pre-processing device—presently in idle position —, while the other wire pre-processing device—in working position—can be used for the production workflow.

A preferred embodiment is characterized in that the first wire transfer device is movable relative to the wire conveyor along the wire transport path, and/or that the second wire transfer device is movable relative to the wire conveyor along the wire transport path. This allows the wire transfer device to be moved away from and towards the wire conveyor, which is particularly advantageous when the wire input is constructed in the form of a convergent orifice, and the wire transfer device or a projecting part thereof protrudes into the convergent orifice in the working position.

A preferred embodiment is characterized in that the first and second wire pre-processing devices and/or the first and second wire transfer devices are supported on a shared carrier, wherein the carrier is movable transversely to the wire transport path, preferably by a drive. In this way, the shift between the working position and the idle position of the respective devices can be performed easily, synchronously and using a small number of drives.

A preferred embodiment is characterized in that the first wire transfer device is movable relative to the carrier, preferably parallel to the wire transport path, preferably by a first drive, and that the second wire transfer device is movable relative to the carrier, preferably parallel to the wire transport path, preferably by a second drive. Thus a simple arrangement for assuring a degree of freedom of movement of the wire transfer device away from and towards the wire conveyor is created.

A preferred embodiment is characterized in that a first wire guide extends between the first wire pre-processing device and the first wire transfer device, wherein the length of the first wire guide is preferably replaceable in the direction of travel, and/or that a second wire guide extends between the second wire pre-processing device and the second wire transfer device, wherein the length of the second wire guide is preferably replaceable in the direction of travel. The guide serves to ensure that when the wire moves out of the operating range of the wire conveyors, in particular in a direction opposite to the working transport direction, the wire is prevented from sagging or buckling between a wire pre-processing device and the associated wire transfer device. A length-adjustable guide addresses the fact that the distance between wire pre-processing device and associated wire transfer device may also be of variable length (for example if the wire transfer device moves away from the wire conveyor and consequently moves towards the wire pre-processing device, and vice versa).

A preferred embodiment is characterized in that the wire guide(s) is/are formed by at least two guide sections that are slidable into each other, preferably in telescoping manner, and/or that the wire guide(s) is/are formed by at least one spring assembly. This makes it possible to compensate for the variable distance between wire pre-processing device and associated wire transfer device.

A preferred embodiment is characterized in that the first wire transfer device and/or the second wire transfer device is/are movable along the wire transport path movable and/or is/are movable out of the wire transport path into an idle position. The shift of the wire transfer device between its working position and its idle position may take place in two stages, and may be effected by at least two degrees of freedom (movement parallel with and movement transversely to the wire transport path). However, it would also be possible to swivel the wire transfer device out of the wire transport path.

A preferred embodiment is characterized in that in its working position the wire transfer device(s) has a preferably replaceable wire guide element, preferably in the form of a guide tube or guide nozzle facing the wire input, wherein when the wire transfer device is in the working position the wire guide element preferably protrudes into a convergent orifice area of the wire conveyor and when the wire transfer device is in a position away from the working position the wire guide element is positioned outside of the convergent orifice area. The wire guide element makes the transfer of the wire to the wire conveyor particularly reliable and error-free.

A preferred embodiment is characterized in that the wire transfer device(s) has/have a wire fixing device, which is operable, preferably by an actuator, between a position that fixes the wire and a position that releases the wire, wherein the wire fixing device preferably has at least one movable fixing element for clamping the wire. The advantage of fixing consists in that the wire is retained in a defined position when the wire transfer device (together with the wire) is moved between its working position and its idle position. This also ensures that the wire is retained in a defined position when it is brought into the operating range of the wire conveyor and is not displaced relative thereto during the movement of the wire transfer device. This in turn enables the end of the wire to be transferred reliably to the wire conveyor.

A preferred embodiment is characterized in that the wire fixing device is movable, preferably by means of a drive, along the wire transport path relative to the wire guide element. In this way, the end of the wire that is to be seized by the wire conveyor may be positioned so as to protrude from the wire guide element to the desired extent. The protruding end section of the wire may then be brought easily into the operating range of the wire conveyor.

A preferred embodiment is characterized in that the wire conveyor can be brought from a working position, in which the wire is transportable by the wire conveyor, into a position in which the wire is released, preferably by means of an actuator which is actuated by a controller. As soon as the wire is released, the wire transfer device is able to move the wire or wire end it holds into or out of the operating range of the wire conveyor.

The wire conveyor is preferably designed in the form of a belt conveyor, wherein the belt conveyor preferably comprises a first (circulating) belt and second (circulating) belt, wherein the wire transport path passes between the first and the second belt. The first belt can be moved away from the second belt (to reach the position in which the wire is released).

A preferred embodiment is characterized in that the wire feeding apparatus is equipped with a controller, which is designed to actuate the wire pre-processing device, the wire transfer device and the wire conveyor, in particular the drives and/or actuators thereof. This enables not only an automated production workflow but also a largely automatic replacement or removal of wires.

A preferred embodiment is characterized in that the wire transfer device(s) has/have at least one sensor which is connected to the controller of the wire feeding apparatus for detecting and/or determining the position of a wire, wherein the sensor is preferably connected to the controller. This makes it possible to define and/or move to the correct position of the wire inside the wire transfer device, e.g. by means of the wire fixing device.

The objective of the invention is also achieved with a wire processing apparatus having at least one wire processing station, in particular a station for cutting to length and/or insulating and/or assembling, and a wire feeding apparatus according to the invention for feeding a wire to the at least one wire processing station.

The objective of the invention is also achieved with a method for handling at least one wire by means of a wire feeding apparatus according to the invention, in particular for feeding a wire to a wire processing station and/or for replacing or removing a wire.

A preferred embodiment is characterized in that in order to replace or remove a wire in/from the wire feeding apparatus, a (first) wire—at least a section of which is located in the operating range of the wire conveyor—is automatically moved out of the operating range of the wire conveyor, wherein the (first) wire is preferably moved automatically into an idle position outside of the wire transport path, and/or that in order to replace a wire in the wire feeding apparatus ae (second) wire is automatically moved from an idle position outside of the wire transport path and into the operating range of the wire conveyor. In this context, the term “automatically” means that the actions described earlier no longer have to be carried out by hand, but are performed fully automatically by means of drives and actuators that are actuated by a controller.

A preferred embodiment is characterized in that in order to replace or remove a wire in/from the wire feeding apparatus,

in a step (a) the wire conveyor transports the wire in reverse, counter to the working transport direction, preferably until the end of the wire is in the area of the wire input of the wire conveyor, and

in a step (b) the first wire transfer device is moved together with the wire from its working position in the area of the wire input of the wire conveyor into an idle position outside the wire transport path, preferably by at least one drive.

A preferred embodiment is characterized in that a wire fixing device of the wire transfer device fixes the wire after step (a), preferably before and/or during step (b), wherein the end of the wire is preferably brought entirely out of the operating range of the wire conveyor by a movement of the wire fixing device in the direction opposite to the working transport direction.

A preferred embodiment is characterized in that in order to carry out step (a) the wire pre-processing device is brought into a position in which the wire is released, preferably by means of an actuator actuated by a controller, preferably by automatic opening of at least one straightening unit of the wire pre-processing device.

A preferred embodiment is characterized in that the movement of the first wire transfer device according to step (b) comprises a movement of the first wire transfer device transversely to the working transport direction, wherein the movement of the wire transfer device according to step (b) preferably comprises a movement in the opposite direction to the working transport direction preceding said transverse movement.

A preferred embodiment is characterized in that the wire feeding apparatus—as described previously—comprises a second wire pre-processing device and a second wire transfer device, and that

in a step (c), which preferably takes place during or after step (b), the second wire transfer device together with a second wire is moved from its idle position into its working position in the area of the wire input of the wire conveyor, and the end (preferably the wire tip) of the second wire is brought into the operating range of the wire conveyor by the second wire transfer device.

A preferred embodiment is characterized in that a wire fixing device of the second wire transfer device fixes the second wire and/or that the end of the second wire (preferably the wire tip) is brought into the operating range of the wire conveyor before and/or during step (c) by moving a wire fixing device of the second wire transfer device in the working transport direction.

A preferred embodiment is characterized in that—after the end of the second wire (preferably the wire tip) has been brought into the operating range of the wire conveyor—the wire conveyor is brought from a releasing position into a closed position, preferably by means of an actuator actuated by a controller, and the wire fixing device is brought into a position in which the wire is released, preferably by means of an actuator actuated by a controller.

A preferred embodiment is characterized in that—after the end of the second wire has been brought into the operating range of the wire conveyor and/or the wire conveyor has been brought from a releasing position into a closed position—the at least one straightening unit of the second wire pre-processing device is closed automatically (in a closed position assigned to the second wire). The value of the closed position can be stored in the dataset on the controller and retrieved from there.

A preferred embodiment is characterized in that—after the wire fixing device has been brought into a position in which the wire is released—the wire conveyor transports the wire in the working transport direction, preferably until the leading end of the wire reaches a predetermined reference position.

A preferred embodiment is characterized in that the wire pre-processing device(s), the wire transfer device(s) and the wire conveyor, in particular the drives and/or actuators thereof, are actuated by a controller.

Further advantages, features and details of the invention may be discerned in the following description, in which exemplary embodiments of the invention are described with reference to the drawing.

The list of reference numerals is an integral part of the disclosure in the same way as the technical content of the claims and figures. The figures are described in sequence and thematically. Identical reference numerals denote identical components, reference numerals with different indices indicate components that are functionally identical or similar.

### BRIEF DESCRIPTION OF THE DRAWINGS

In the drawing:

FIG. 1 shows an embodiment of a wire feeding apparatus according to the invention,

FIG. 2 shows a further embodiment of a wire feeding apparatus according to the invention,

FIG. 3 shows the wire feeding apparatus of FIG. 2 after replacement of a wire,

FIG. 4 is an enlarged representation of the wire transfer device,

FIG. 5 is an enlarged representation of the wire fixing device,

FIG. 6 illustrates the control level of a wire feeding apparatus with the controller and the drives, actuators and sensors connected to the controller.

### DETAILED DESCRIPTION OF THE PREFERRED EMBODIMENTS

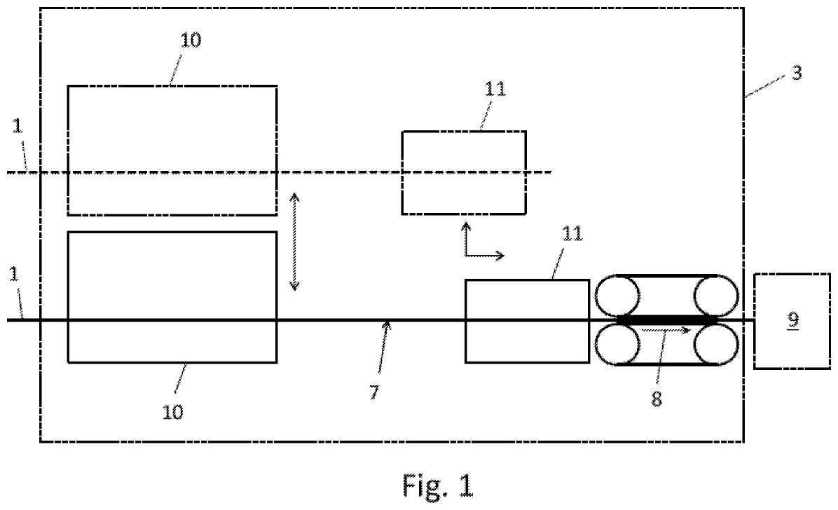

FIG. 1 shows a first embodiment of a wire feeding apparatus 3. It is used to feed a wire 1 to a wire processing station 9. Along a wire transport path 7, the wire feeding apparatus 3 comprises a (first) wire pre-processing device 10, with which the wire 1 is pre-processed. This may be for example a straightening unit for straightening the wire 1. In addition to or instead of straightening, one or more other pre-processing operation(s) might also be carried out in the wire pre-processing device 10, e.g., marking, labelling, colouring and/or insulation stripping (parts and/or sections thereof), incisions, etc.

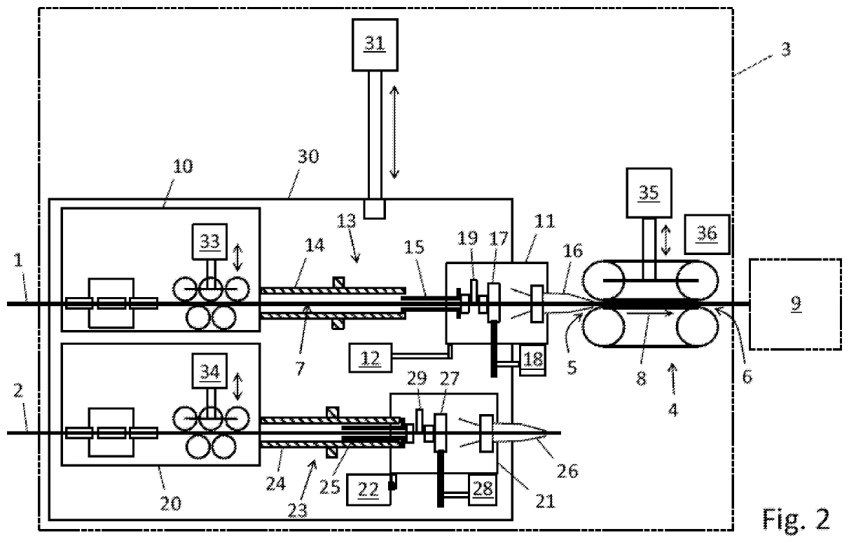

The wire feeding apparatus 3 further comprises a wire conveyor 4 for conveying the wire 1 along the wire transport path 7 in a working transport direction 8, with a wire input 5 and a wire output 6 (as may also be seen in FIG. 2). The wire input 5 faces the wire transfer device 11. The wire output 6 faces the processing station 9.

In the embodiment shown, the wire conveyor 4 is constructed in the form of a belt conveyor, wherein the belt conveyor comprises a first (circulating) belt and a second (circulating) belt, and the wire transport path 7 passes between the first and second belts. The first belt may be movable away from the second belt (in order to reach a position in which the wire 1 is released).

The wire feeding apparatus 3 further comprises a (first) wire transfer device 11 assigned to the (first) wire pre-processing device 10 for transferring the wire 1 to the wire conveyor 4 in the area of the wire input 5.

In its working position, the first wire transfer device 11 is positioned in the area of the wire input 5 of the wire conveyor 4, and is preferably movable from its working position by at least one drive.

In FIG. 1, the wire transfer device 11—as well as the wire pre-processing device 10—is in the working position (solid lines). The standby or idle position of the wire transfer device 11—as well as that of the wire pre-processing device 10—is indicated by dashed lines. In the idle position, the wire transfer device 11 is positioned at a (greater) distance from the wire conveyor 4 and/or outside of the wire transport path 7 (FIG. 1).

In the idle position of the wire transfer device 11 (represented with dashed lines), the wire 1 can be replaced or way for its next insertion. The wire held by the wire transfer device 11 may be brought automatically into the wire transport path and into the operating range of the wire conveyor 4 again. For this, the wire transfer device 11 only needs to be moved in the direction of the double-headed arrows.

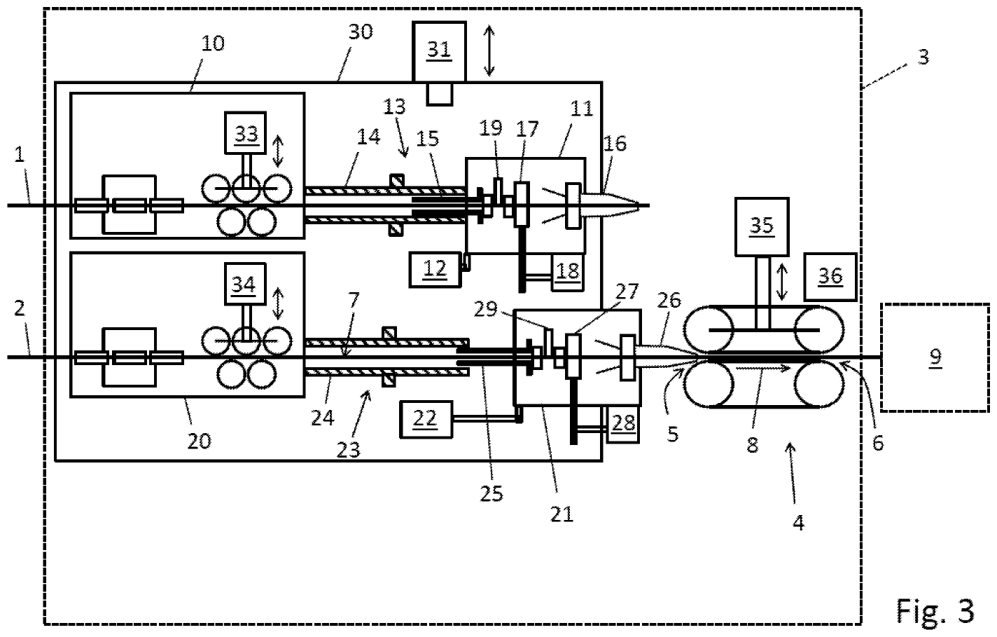

FIGS. 2 and 3 show a further embodiment, in which the wire feeding apparatus 3 comprises a second wire pre-processing device 20—in addition to the first wire pre-processing device 10 —, which preferably also includes a straightening unit for straightening a wire 2.

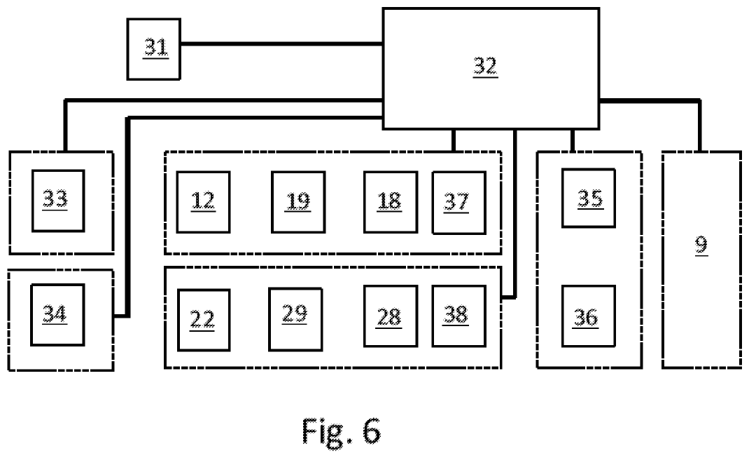

The straightening units of the wire pre-processing devices 10, 20 as shown in FIGS. 2 and 3 may each by brought into a position in which the wire 1 is released by means of an actuator 33, 34—actuated by a controller 32 (see FIG. 6) preferably by opening of the respective straightening unit (i.e. the rollers are moved apart).

A second wire transfer device 21 (for transferring a second wire 2 to the wire conveyor 4 in the area of the wire input 5) is assigned to the second wire pre-processing device 20. In its working position (FIG. 3), the second wire transfer device 21 is positioned in the area of the wire input 5 of the wire conveyor 4, and is movable from its working position preferably by at least one drive 22, 31. In FIG. 2, the second wire transfer device 21 together with the second wire pre-processing device 20 is in the idle position.

The first wire transfer device 11 together with the first wire pre-processing device 10 is in its working position in FIG. 2 and in its idle position in FIG. 3.

In its working position, the first wire pre-processing device 10 is arranged in the wire transport path 7 (FIG. 2). It may be movable from the working position into an idle position outside of the wire transport path 7 by a drive 31 (FIG. 3). In its working position, the second wire pre-processing device 20 is arranged in the wire transport path 7 (FIG. 3). It may be movable from the working position into an idle position outside of the wire transport path 7 by a drive 31 (FIG. 2).

The first wire transfer device 11 and the second wire transfer device 21 may each be movable relative to the wire conveyor 4 along the wire transport path 7 by means of a (dedicated) drive 12, 22.

As may be seen in FIGS. 2 and 3, the first and second wire pre-processing devices 10, 20, and optionally also the first and second wire transfer devices 11, 21, may be supported on a shared support or carrier 30. The carrier 30 may be movable transversely, preferably perpendicularly to the wire transport path 7 by a drive 31.

In this context, the first wire transfer device 11 is mounted so as to be movable relative to the carrier 30 (in this case parallel to the wire transport path 7) by means of a first drive 12. The second wire transfer device 21 is also mounted so as to be movable relative to the carrier 30 (in this case parallel to the wire transport path 7) by means of a second drive 22.

In this way, it may be ensured simply that the first wire transfer device 11 and/or the second wire transfer device 21 is/are movable along the wire transport path 7 and/or is/are movable into an idle position out of the wire transport path 7—that is to say transversely to the wire transport path 7.

A wire guide 13, 23 may be provided in each case between the first wire pre-processing device 10 and the first wire transfer device 11 and between the second wire pre-processing device 20 and the second wire transfer device 21. The lengths of the wire guide(s) 13, 23 are preferably variable in the direction of travel (that is to say along the wire transport path 7).

The length adjustment capability may be realised for example by at least two guide sections 14, 15; 24, 25 which are slidable into each other, preferably in telescoping manner. The wire guide(s) 13, 23 might also be formed by at least one spring assembly whose length is variable.

The wire transfer device(s) 11, 21 may include a preferably replaceable wire guide element 16, 26 which in its working position faces the wire input 5 of the wire conveyor 4. This may be constructed in the form of a guide tube or a guide nozzle. In the working position of the respective wire transfer device 11, 21, the wire guide element 16, 26 preferably protrudes into a convergent orifice area of the wire conveyor 4 (FIGS. 2, 3). In a position in which it is moved out of the working position, the wire guide element 16, 26 is located outside the convergent orifice area of the wire conveyor 4.

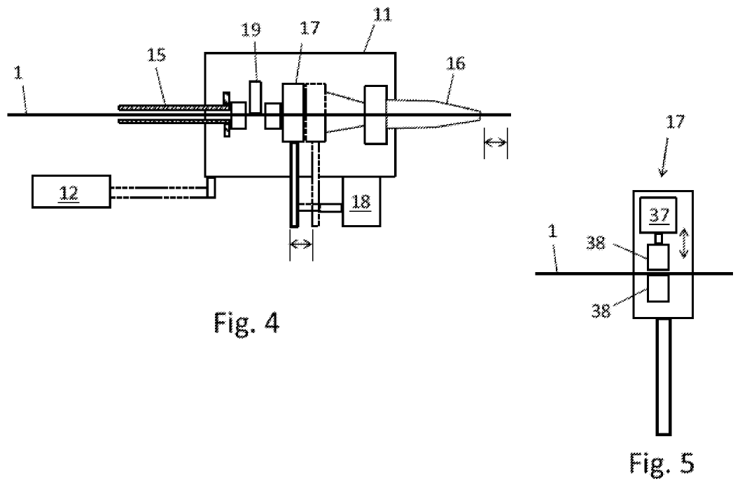

FIGS. 2 and 3 show, and FIGS. 4 and 5 show in detail that the wire transfer devices may each include a wire fixing device 17, 27 which is operable, in this case by an actuator 37 (FIG. 5), between a position in which it fixes the wire 1, 2 and a position in which the wire 1, 2 is released. The wire can be clamped by a fixing element 38, which is movable towards another fixing element 38 by means of the actuator 37.

The wire fixing device 17, 18 is movable relative to the wire guide element 16, 26 along the wire transport path 7. For this purpose, drives 18, 28 may be provided.

The wire conveyor 4 may be brought from a working position, in which the wire 1, 2 is transportable by the wire conveyor 4, into a position in which the wire 1, 2 is released, preferably by means of an actuator 35 which is actuated by a controller 32.

The transport drive 36 of the wire conveyor 4—that is to say the drive which causes the wire to be transported—is represented schematically in FIGS. 2 and 3.

As may be seen in FIG. 6, the wire feeding apparatus 3 also has a controller 32, which is designed to actuate the wire pre-processing device 10, 20, the wire transfer device 11, 21 and the wire conveyor 4, in particular the drives 12, 22, 18, 28, 31, 36 and/or actuators 33, 34, 35, 37 thereof.

The wire transfer device(s) 11, 21 preferably has/have at least one sensor 19, 29 which is connected to the controller 32 of the wire feeding apparatus 3 for detecting and/or determining the position of a wire 1, 2, wherein the sensor 19, 29 is preferably connected to the controller 32.

The combination of a wire feeding apparatus 3 with at least one downstream wire processing station 9, in particular a station for cutting to length and/or an insulation stripping station and/or an assembly station, makes up a wire processing apparatus.

Each of the drives 12, 22, 18, 28, 31, 36 described above may include an electric, magnetic, pneumatic and/or hydraulic drive among others, and may be embodied for example as a motor, cylinder or cylinder-piston unit, toothed rack etc. The actuators 33, 34, 35, 37 described above may be embodied in the same or similar manner. Accordingly, the actuators may be designed to be actuated electrically, magnetically, pneumatically and/or hydraulically. It is preferable if at least some, preferably all drives and actuators have a control interface, via which they are connected to the controller 32 (by cable or wirelessly). The sensors 19, 29 of the wire transfer device 11, 21—which serve to detect and/or determine the position of a wire—may be for example optical sensors (including cameras), contact sensors, magnetic sensors or capacitive sensors.

In the following text, the processes that may be carried out with the wire feeding apparatus 3 for handling a wire 1, 2, in particular for feeding a wire 1, 2 to a wire processing station 9 and/or replacing or removing a wire 1, 2 are described in greater detail.

Thus for example, in order to replace or remove a wire 1, 2 in/from the wire feeding apparatus 3, the wire 1 (currently in positioned in the wire conveyor 4) may be moved out of the wire conveyor 4 automatically. To do this, the wire conveyor 4 is operated in the direction opposite to the working transport direction, so that the wire in the wire input 5 comes out. Then, the wire 1 is automatically moved to an idle position outside of the wire transport path 7 (i.e. the wire is moved transversely to the wire transport path 7) by means of the wire transfer device 11. The idle position of the wire transfer device 11 with the wire 1 is shown in FIG. 3.

In this context, in a step (a) the wire conveyor 4 may transport the wire 1 backwards, in the direction opposite to the working transport direction 8, preferably until the end of the wire is positioned in the area of the wire input 5 of the wire conveyor 4.

In a step (b), the first wire transfer device 11 together with the wire 1 may be moved from its working position in the area of the wire input 5 of the wire conveyor 4 into an idle position outside of the wire transport path 7 (see dashed line representation of FIG. 1 or FIG. 3). This is brought about preferably by at least one drive 12, 31.

After step (a), preferably before and/or during step (b), the wire fixing device 17 of the wire transfer device 11 may fix the wire 1. In such case, the end of the wire is preferably brought out of the operating range of the wire conveyor 4 by a movement of the wire fixing device 17 in the direction opposite to the working transport direction 8.

In order to carry out step (a), the wire pre-processing device 10 may be brought into a position in which the wire 1 is released, preferably by means of an actuator 33 which is actuated by a controller 32, for example by opening of the at least one straightening unit of the wire pre-processing device 10.

The movement of the first wire transfer device 11 according to step (b) may include a movement transversely to the working transport direction 8, optionally with a movement opposite to the working transport direction 8 preceding said transverse movement.

In the case of two wire transfer devices (FIGS. 2 and 3), in a step (c), which preferably takes place during or after step (b), the second wire transfer device 21 together with a second wire 2 is moved out of its idle position and into its working position in the are of the wire input 5 of the wire conveyor 4, and the end (preferably the wire tip) of the second wire 2 is brought into the operating range of the wire conveyor 4 by the second wire transfer device 21.

In addition, the wire fixing device 27 of the second wire transfer device 21 may fix the second wire 2 before and/or during step (c). The end of the second wire 2 may further be brought into the operating range of the wire conveyor 4 by moving the wire fixing device 27—which is fixing the second wire 2—of the second wire transfer device 21 in working transport direction 8.

After the end of the second wire 2 has been brought into the operating range of the wire conveyor 4, the wire conveyor 4 may be moved from a releasing position into a closed position, preferably by means of an actuator 35 which is actuated by a controller 32. The wire fixing device 27 is then also brought into a position in which the wire 2 is released, preferably by means of an actuator 37 which is actuated by a controller 32.

After the wire fixing device 27 has been brought into a position in which the wire 2 is released, the wire conveyor 4 transports the wire 2 in working transport direction 8, preferably until the leading end of the wire 2 reaches a predetermined reference position (e.g. definitive for the processing station).

In automated operation, the wire pre-processing device(s) 10, 20, the wire transfer device(s) 11, 21 and the wire conveyor 4, in particular the drives 12, 22, 18, 28, 31, 36 and/or actuators 33, 34, 35, 37 thereof, are actuated by a controller 32.

The invention is not limited to the embodiments described and the aspects highlighted therein. Rather, a wide variety of variations are possible within the inventive thought, which fall within the scope of activities by a person skilled in the art. By combining the means and features described, it is also possible to realise further variants without departing from the scope of the invention.

### LIST OF REFERENCE NUMERALS

1 First wire
2 Second wire
3 Wire feeding apparatus
4 Wire conveyor
5 Wire input
6 Wire output
7 Wire transport path
8 Working transport direction
9 Processing station
10 First wire pre-processing device
11 First wire transfer device
12 Drive for the first wire transfer device 11
13 Wire guide
14 Guide section
15 Guide section
16 Wire guide element
17 Wire fixing device
18 Drive for wire fixing device 17
19 Sensor
20 Second wire pre-processing device
21 Second wire transfer device
22 Drive for the second wire transfer device 21
23 Wire guide
24 Guide section
25 Guide section
26 Wire guide element
27 Wire fixing device
28 Drive for wire fixing device 27
29 Sensor
30 Carrier
31 Drive for the Carrier 30
32 Controller
33 Actuator for the first wire pre-processing device 10
34 Actuator for the second wire pre-processing device 20
35 Actuator for the wire conveyor 4
36 Transport drive of the wire conveyor 4
37 Actuator of the wire fixing device 27
38 Fixing element of the wire fixing device 27

1-27. (canceled)

28. A wire feeding apparatus, in particular a cable feeding apparatus, for feeding a wire, in particular a cable, to a wire processing station having a wire transport path, the apparatus comprising:
a first wire pre-processing device including at least one straightening unit for straightening a wire;
a wire conveyor for conveying the wire along the wire transport path in a working transport direction, the wire conveyor having a wire input; and
a first wire transfer device assigned to the first wire pre-processing device for transferring the wire to the wire conveyor in the area of the wire input,
wherein the first wire transfer device, in its working position, is positioned in the area of the wire input of the wire conveyor and is movable out of its working position.

29. The wire feeding apparatus according to claim 28, wherein the wire feeding apparatus has a second wire pre-processing device including at least one straightening unit for straightening a wire, and a second wire transfer device assigned to the second wire pre-processing device for transferring the wire to the wire conveyor in the area of the wire input, and that in its working position the second wire transfer device is located in the area of the wire input of the wire conveyor, and is movable out of its working position, preferably into an idle position outside of the wire transport path, preferably by at least one drive.

30. The wire feeding apparatus according to claim 28, wherein in its working position the first wire pre-processing device is arranged in the wire transport path, and is movable out of the working position into an idle position outside of the wire transport path preferably by a drive, and/or that in its idle position the second wire pre-processing device is located outside of the wire transport path, and is movable out of the idle position into a working position in which the second wire pre-processing device is positioned in the wire transport path.

31. The wire feeding apparatus according to claim 28, wherein the first wire transfer device is movable, preferably by a drive, along the wire transport path relative to the wire conveyor, and/or that the second wire transfer device is moveable, preferably by a drive, along the wire transport path relative to the wire conveyor.

32. The wire feeding apparatus according to claim 28, wherein the first and second wire pre-processing devices and/or the first and second wire transfer devices are supported by a shared carrier, wherein the carrier is transversely movable perpendicularly to the wire transport path.

33. The wire feeding apparatus according to claim 28, wherein the first wire transfer device, by a first drive, is movable relative to the carrier and parallel to the wire transport path, and that the second wire transfer device, by a second drive, is movable relative to the carrier and parallel to the wire transport path.

34. The wire feeding apparatus according to claim 28, wherein a first cable guide extends between the first wire pre-processing device and the first wire transfer device, wherein the length of the first wire guide can preferably be varied in the guide direction, and/or that a second wire guide extends between the second wire pre-processing device and the second wire transfer device, wherein the length of the second wire guide can be varied in the guide direction.

35. The wire feeding apparatus according to claim 34, wherein the wire guide(s) is/are made from at least two guide sections that are slidable into each other, in telescoping manner, and/or that the wire guide(s) is/are formed by at least one spring assembly.

36. The wire feeding apparatus according to claim 28, wherein the first wire transfer device and/or the second wire transfer device is/are movable along the wire transport path and/or is/are movable out of the wire transport path into an idle position.

37. The wire feeding apparatus according to claim 28, wherein in its/their working position the wire transfer device(s) has/have a wire guide element facing the wire input, in the form of a guide tube or guide nozzle, wherein with the wire transfer device in the working position, the wire guide element preferably protrudes into a convergent orifice area of the wire conveyor, and in a position in which it is moved out of the working position, is located outside of the convergent orifice area.

38. The wire feeding apparatus according to claim 28, wherein the wire transfer device(s) has/have a wire fixing device, which is operable between a position that fixes the wire and a position that releases the wire, wherein the wire fixing device includes at least one movable fixing element for clamping the wire.

39. The wire feeding apparatus according to claim 37, wherein the wire fixing device is movable relative to the wire guide element along the wire transport path, by means of a drive.

40. The wire feeding apparatus according to claim 28, wherein the wire conveyor can be brought, by an actuator which is actuated by a controller from a working position, in which the wire can be transported by the wire conveyor, into a position in which the wire is released.

41. The wire feeding apparatus according to claim 28, wherein the wire feeding apparatus has a controller designed to actuate the wire pre-processing device, the wire transfer device and the wire conveyor.

42. The wire feeding apparatus according to claim 28, wherein the wire transfer device(s) has/have at least one sensor connected to the controller of the wire feeding apparatus for detecting and/or determining the position of a wire, wherein the sensor is connected to the controller.

43. A cable processing apparatus, having at least one wire processing station, the wire processing station including a station for cutting to length and/or an insulation stripping station and/or an assembly station, and a wire feeding apparatus for feeding a wire to the at least one wire processing station, wherein the wire feeding apparatus is embodied according to claim 28.

44. A method for handling a cable by means of a wire feeding apparatus, the apparatus configured for feeding a wire to a wire processing station and/or for replacing or removing a wire wherein the wire feeding apparatus is embodied according to claim 28.

45. The method according to claim 44, wherein in order to replace or remove a wire in/from the wire feeding apparatus, a wire is automatically moved out of the operating range of the wire conveyor, wherein the wire is preferably moved automatically into an idle position outside of the wire transport path, and/or that in order to replace a wire in the wire feeding apparatus a wire is automatically moved out of an idle position outside of the wire transport path and into the operating range of the wire conveyor.

46. The method according to claim 44, wherein in order to replace or remove a wire in/from the wire feeding apparatus, in a step (a) the wire conveyor moves the wire backwards, in the opposite direction to the working transport direction, preferably until the end of the wire is in the area of the wire input of the wire conveyor, and in a step (b) the first wire transfer device together with the wire is moved out of its working position in the area of the wire input of the wire conveyor and into an idle position outside of the wire transport path, preferably by at least one drive.

47. The method according to claim 46, wherein after step (a) a wire fixing device of the wire transfer device fixes the wire, wherein the end of the wire is preferably brought entirely out of the operating range of the wire conveyor by a movement of the wire fixing device in the direction opposite to the working transport direction.

48. The method according to claim 46, wherein in order to perform step (a) the wire pre-processing device is brought into the position in which the wire is released by opening of the at least one straightening unit of the wire pre-processing device.

49. The method according to claim 46, wherein the movement of the first wire transfer device according to step (b) comprises a movement of the first wire transfer device transversely to the working transport direction, wherein the movement of the wire transfer device according to step (b) preferably comprises a movement that precedes said transverse movement in the opposite direction to the working transport direction.

50. The method according to claim 44, wherein the wire feeding apparatus is embodied according to claim 29, and that in a step (c), which is carried out during or after step (b), the second wire transfer device together with a second wire is moved out of its idle position into its working position in the area of the wire input of the wire conveyor, and the end of the second wire is brought into the operating range of the wire conveyor by the second wire transfer device.

51. The method according to claim 50, wherein a wire fixing device of the second wire transfer device fixes the second wire before and/or during step (c), and/or that the end of the second cable is brought into the operating range of the wire conveyor by moving a fixing device of the second wire transfer device that fixes the second wire in the working transport direction.

52. The method according to claim 51, wherein after the end of the second wire has been brought into the operating range of the wire conveyor, the wire conveyor is brought from a releasing position into a closed position, preferably by means of an actuator actuated by a controller, and the wire fixing device is brought into a position in which the wire is released, preferably by means of an actuator actuated by a controller.

53. The method according to claim 52, wherein after the wire fixing device has been brought into a position in which the wire is released, the wire conveyor transports the wire in the working transport direction, preferably until the leading end of the wire reaches a predetermined reference position.

54. The method according to claim 44, wherein the wire pre-processing device(s), the wire transfer device(s) and the wire conveyor, in particular the drives and/or actuators thereof, are actuated by a controller.
